(19) United States
(12) Patent Application Publication
(10) Pub. No.: US 2004/0142200 A1
(43) Pub. Date: Jul. 22, 2004

(54) Method for manufacturing erosion-resistant wearing parts and a wearing part

(75) Inventors: Jari Liimatainen, Tampere (FI); Mikko Malkamaki, Tampere (FI); Kari Peltomaki, Tampere (FI); Jukka Lehtonen, Kyronlahti (FI)

Correspondence Address: BURNS DOANE SWECKER & MATHIS L L P, POST OFFICE BOX 1404, ALEXANDRIA, VA, 22313-1404, US

(73) Assignee: Metso Powdermet Oy, Tampere, FL

(21) Appl. No.: 10/651,979

(22) Filed: Sep. 2, 2003

(30) Foreign Application Priority Data
Aug. 30, 2002 (FI) 20021550

(51) Int. Cl. B32B 15/16

(52) U.S. Cl. 428/553; 419/68

(57) ABSTRACT

A method of manufacturing erosion-resistant wearing parts and a wearing part are disclosed, whereby the wearing part manufactured according to the invention comprises at least one hard powder composition (A) and at least one ductile powder composition (B) that together are densified in a single pressing step into an entirely dense product. According to the method, the temperature coefficient of the hard powder composition (A) is controlled by keeping the temperature coefficient of the hard powder composition smaller than that of the encapsulating powder composition (B), whereby the hard powder composition (A), with the exception of the outer erosion-subjected surface of the wearing part, remains entirely encapsulated by powder composition (B) so effectively that the imposed eroding forces cannot essentially extrude the hard powder composition (A) out from the wearing part through its erosion-subjected outer surface.

The present invention relates to a method for manufacturing erosion resistant wearing parts by a powder-metallurgical multimaterial technique.

### BACKGROUND OF THE INVENTION

Cone and gyratory crushers are used for compressive crushing of different kinds of minerals. The material being crushed causes abrasive erosion of the surfaces of crusher components serving as the wearing parts of the inner and outer liner that impart the compressive crushing force. The amount of erosion on one hand correlates with the properties (compressive strength, abrasiveness) of the erosive mineral material and on the other hand depends on the type/use of the crusher and its gap shape. Erosion of wearing parts results from the relative motion of the mineral particles in regard to the metallic crusher surface and from the penetration of the rock material into the metallic surface. The former abrasive mechanism causes cutting wear when small metal chips are removed from the surface in the same fashion as in mechanical machining. The latter wear mechanism is caused by extrusion of metal burrs from the metallic surface when a mineral particle penetrates into the metallic base material. The extruded metal burrs detach later from the surface of the metallic base material by undergoing breaking, fatigue deformation or chipping.

Mostly due to the compressive forces required for comminution, the wear rate is highest within the crushing zone of the wearing parts principally performing the reduction of the mineral materials.

One conventional technique of improving the erosion resistance of wearing parts under different wearing conditions involving abrasive wear is to embed hard powder particles such as carbide, nitride, oxide and boride grains into a metallic matrix. The materials thus obtained are called metal matrix composites. Suitable selection of the volume proportions, size distribution and hardness of the different powder grains as well as of the hardness and toughness of the matrix component makes it possible to obtain a desired combination of resistance to wear and mechanical properties.

A drawback of composite materials containing hard carbide grains or other particles is a lower toughness and more complicated fabrication in terms of heat treatment and machinability, among others. Due to their lesser toughness, composite materials cannot be used as monolithic wearing parts in locations subjected to strong impact stresses, but rather, the risk of macroscopic cracks must be eliminated by manufacturing the body structure of the part from a sufficiently ductile base material of sufficient strength while a metal matrix composite is added only on critical areas subject to wear. Generally, structures implemented in this fashion are called multimaterial components. In addition to their highly reliable usability, the benefits of multimaterial components include an easier machinability inasmuch as the deposition of the difficult-to-machine metal matrix composites on the wearing surfaces alone allows easier machining of the other surfaces of the component.

Multimaterial components have been fabricated using powder-metallurgical techniques such as hot isostatic pressure sintering using the solid base material structure as a body of the component. Herein, a desired area of the base material surface is encapsulated under a 2 to 3 mm thick plate, whereupon the thus created void is filled with a metallurgical powder, is next evacuated, then sealed and finally the powder is densified by hot isostatic pressing, whereby the powder is fused to the solid base material surface by a diffusion bond. As drawback of this method is that the interface formed between the solid base material and the sintered powder is very abrupt meaning that the bond will readily be subjected to high stresses. The large residual stresses thus caused lead to fractures in the bond interface and, particularly, in the brittler one of the bonded materials either during manufacture or due to stresses occurring during service. The use of a solid base material requires a high degree of cleanliness from the surfaces to be bonded, since even the slightest impurities cause a deterioration of the bond properties. Moreover, the use of a solid base material needs an extra manufacturing step firstly involving the manufacture of the base material, then the machining thereof and finally a careful cleaning of its surfaces, all of them obviously increasing the manufacturing costs of the component.

One of the prior-art attempts to reduce stresses due to the different temperature coefficients of expansion in the materials being bonded is based on the so-called gradient structures having a gradient transition region forming an interface between the materials bonded to each other. These kinds of embodiments are described in the methods disclosed in patent publications U.S. Pat. No. 4,368,788 and U.S. Pat. No. 5,762,843 related to tool manufacture. In the method of patent publication U.S. Pat. No. 4,368,788, the metallurgical powders are fed into a mixing chamber, wherefrom the powders are dispensed into a mold to form the desired types of layered structures, wherein the different materials gradually change from one material into another. The manufacture of these kinds of substantially continuous gradient structures is difficult and even incompatible with certain product geometries. Furthermore, a damage in the interface bond between the different material regions implemented according to the methods of patent publications U.S. Pat. No. 4,368,788 and U.S. Pat. No. 5,762,843 inevitably leads to a loss of the component functionality inasmuch as the bond structure and lack of compressive force by the surrounding material does not provide a mechanical bond of the wear-resistant surface material to the base material. Patent publication U.S. Pat. No. 5,762,843 teaches the use of various physically or chemically removable partitions to separate the different material regions from each other. Particularly the removal of the chemically removable partitions requires a separate workstep that may affect the quality of the end product in the case that contaminants remain in the end product.

A tough and wear-resistant metal matrix composite material can be used to form a separating interface between, e.g., intermediate plates of steel that are embedded in fortified products. Also in these cases, the interface bond between the plates becomes abrupt and, moreover, the surface preparation of the intermediate plates requires an additional workstep that is very labor-intensive and, hence, costly. Also herein, similarly to any other unyielding powder-metallurgical bond, the function of the bond is extremely sensitive to surface quality and possible contaminations thereof.

### SUMMARY OF THE INVENTION

In the method according to the invention, the entire component is manufactured from a powdered material by compaction in a single pressing operation, wherein a wear-resistant metal matrix composite powder (A) and another more ductile powder (B) of a non-wear-resistant material are directly bonded to each other without any intermediate layers. Thus, the manufacture of multimaterial components from a powder material alone becomes possible by virtue of using partition plates that are stepwise removed during the filling of the mold with the powder material or, alternatively, by designing and shaping the component so that no partition is required. Furthermore, no separate gradient region, gradually changing from one material to the next, is needed during the powder fill-up, because the proper selection of the materials and, particularly, the management of their thermal properties by controlled addition of ceramic particles is implemented in a fashion that prevents the formation of excessive residual tensional stresses. In certain component types it is even possible to perform the powder fill-up without using the stepwise removed partition plates.

Excessive intermixing of different powder types must, however, be avoided meaning that conventional vibrating compaction of the mold during filling-up shall be avoided or at least restricted to the minimum.

More specifically, the manufacturing method according to the invention is characterized by what is stated in the characterizing part of claim 1 and the wearing part according to the invention is characterized by what is stated in the characterizing part of claim 5.

In the multimaterial component according to the invention, the wear-resistant material is advantageously located so as to prevent the material from being subjected to stresses higher than its load-bearing capability in the component. Additionally, the location of the wear-resistant material in the component must be designed such that cracking of the material will not necessarily lead to detachment of the crack-defected surface from the base material, but rather, the surface material even after developing fractures can be retained in the base material by a mechanical hindrance mechanism nevertheless that the interface between the materials has undergone a partial detachment. This can be implemented in the best fashion by performing the material selection so that at the end of all the manufacturing steps a compressive stress remains in the wear-resistant material and, additionally, the wear-resistant material becomes metallurgically bonded over a maximally large area to the tougher base material. This condition is accomplished by way of controlling the temperature coefficients of expansion between the powder material. The control of temperature coefficients of expansion takes place by complementing the powder material with additives that either decrease or increase the temperature coefficients of expansion or, alternatively, the metal powder is complemented with ceramic particles that generally have a lower temperature coefficient of expansion than metals. If the ductile powder composition (B) encapsulating the hard powder composition (A) has a temperature coefficient of expansion lower than that of the hard powder composition (A), the hard powder material can be encapsulated under a sustained compressive stress that on one hand reduces its sensitivity to cracking and on the other hand retains the hard material by a crimping mechanism maximally tenaciously locked between the base material matrix regions formed by the ductile powder even after the metallurgical bond between the two materials may already have undergone partial cracking failure. In the context of the present text, a metallurgical bond refers to such a perfect bond between two materials (A) and (B) that is established therebetween as a result of metal diffusion during a hot isostatic pressing operation.

Additionally, the component design shall aim to achieve a structure wherein the crushing forces occurring during service are prevented from extruding the hard material (A) out from the matrix of the ductile material (B) through the side not encapsulated by material (B). Herein, even a separating fracture of materials (A) and (B) at their interfaces allows the hard material (A) to stay adhering to the component by virtue of the mechanical locking and compressive stress imparted by material (B). As the crushing forces generally appear as compressive stresses within the zone of the crushing forces, these external loads push the hard material (A) toward the matrix formed by the ductile material (B), whereby the detachment risk of the hard material is reduced and, additionally, the formation of bending stresses and significant tensional stresses is prevented.

The composition of wear-resistant surfacing materials is selected according to the abrasiveness of rock material to be crushed and the crusher application. At least one of the powder material compositions to be used in the present structure of a multi-material component comprises gas-atomized steel powder (I) and a hard powder (II), containing a ceramic material advantageously by at least 70 vol. %, most advantageously by at least 85 vol. %.

The composition of the gas-atomized steel powder (I) must provide sufficient hardness and toughness so that it renders in combination with the hard powder material (II) the desired properties to the surface required to have a high resistance to wear. Depending on the application, the composition of the steel powder advantageously is 0.3-3.5 wt. % carbon, 0.5-20 wt. % chromium, 0-5 wt. % molybdenum, less than 2 wt. % manganese and less than 2 wt. % silicon, most advantageously, 2-3 wt. % carbon, 3-8 wt. % chromium, 0.5-2 wt. % molybdenum, less than 2 wt. % manganese and less than 2 wt. % silicon. Additionally, the powder should contain 3-20 wt. % alloying compounds capable of forming MC-type carbides, such compounds being vanadium, niobium, titanium and tungsten, most advantageously 5-15 wt. %. The hard powder (II) may be entirely ceramic or, alternatively, such a mixture of ceramic compound and a metallic binder wherein the proportion of the metallic binder is less than 30 wt. %, most advantageously less than 15 wt. %. Suitable ceramic grain types are, e.g., tungsten carbide, niobium carbide, vanadium carbide, titanium carbide and aluminum oxide grains.

Advantageously, the hard material (A) of the wearing part has a composition that gives a structure wherein the hard particles (II) can form isolated, maximally discontinuous regions encapsulated in the matrix formed by the steel powder (I). This condition can be optimally attained by making the grain size of the hard particles (II) substantially smaller than the grain size of the steel powder (I). Most advantageously, the average grain size of the steel powder should be less than ½ of the average grain size of the hard particles (II) in order to avoid, particularly in very large components, excessively large local agglomerations of hard particles (II), which condition is met advantageously by keeping average grain size of steel powder (I) smaller than ⅓ of the average grain size of the hard particles (II). The above-mentioned agglomerations may cause local regions of inferior fracture toughness and fatigue strength. However, the maximum grain size of the hard particles must be kept sufficiently small to avoid the formation of excessively large microfractures under such erosive conditions wherein cracking of the hard particles (II) cannot positively be avoided. In these cases it is necessary take into account the fracture toughness of the steel powder (I) forming the matrix component. Advantageously, the grain size of the hard particles (II) should be in the order of 200-1000 μm and for extremely heavily loaded applications in the order of 200-500 μm. The volume proportion of the hard particles should advantageously be in the order 10-50 vol. % and for extremely heavily loaded applications in the order of 10-20 vol. %. The larger the volume proportion of the hard particles the larger must be the ratio of the average grain size of the hard particles to the average grain size of the steel powder particles.

The base material of the multimaterial wearing part is preferably selected to be a steel grade of sufficient toughness, strength and fatigue strength that is well compatible as to its metallurgical and thermal properties with the other material component of high resistance to wear.

In as much as local overload situations are unavoidable in crusher applications due to entry of extremely large mineral material objects or even metallic contaminations, the wear-resistant portion of the crushing component or its interface with the ductile material may be subjected to loads so high that even the fracture toughness is exceeded. Hence, the design of the multimaterial component is advantageously such that the wear-resistant, brittler material (A) continuously stays under a compressive stress during the use of the component. This situation can be attained by selecting, among other factors, the wear-resistant material (A) such that its temperature coefficient of expansion is smaller than that of the ductile base material (B) encapsulating the wear-resistant material. An alternative technique of providing the same condition is to select the wear-resistant material (A) such that the changes in its specific volume due to phase changes during cooling in manufacturing, after either the compaction or the thermal treatment of the component, are larger than those of the encapsulating base material (B).

Optimally, the manufacture of the component takes place by first making a mold from sheet steel, typically having a thickness less than 10 mm, into which the different powders are metered. After filling, the mold is evacuated and sealed. The mold is transferred into a hot isostatic press unit, wherein the powder is densified with the help of in an isostatically applied pressurized gas atmosphere and elevated temperature, whereby a bond is established between the different powder types. The process parameters during hot isostatic pressing are advantageously as follows: pressure 80-150 MPa and temperature 1000-1200° C., most advantageously pressure 90-110 MPa and temperature 1050-1130° C. Elevating the process temperature too high accelerates the reaction between the hard particles (I) of the hard material (A) and the metal powder (II), whereby on one hand the toughness of the metal region (II) is reduced and on the other hand the volume proportion of the hard particles (I) remains lower.

In certain cases it may, however, be advantageous to leave a certain amount of the encapsulating mold material on those areas of the component, for instance, that are to be machined, whereby surfaces needing postmachining are easier to work. Furthermore, the softer encapsulating mold material left on the crushing surface allows the wear profile of the crushing surface and also the crushing process itself as the softer areas undergo faster erosion than the material (A) of higher resistance to wear.

Among other features, the method according to the invention offers the following benefits:

(a) through controlled management of temperature coefficients of expansion and phase changes, proper selection of the wear-resistant powder composition (A) and the ductile powder composition (B) it becomes possible to design a wearing part according to the invention so as to retain the wear-resistant powder material under a substantially continuous compressive stress, whereby the durability of the interface with the base material is increased and, even when the interface is fractured, to retain material (A) adhering to the component;

(b) by virtue of the multimaterial component design, a structure can be created wherein the crushing forces occurring in a crushing operation cannot generate a force vector directed so as to extrude the hard material (A) out from the matrix of the ductile base material (B) at the surface of the latter where the hard material is not encapsulated in the base material (B); and

(c) proper selection of the grain size of the steel powder component (II) of the wear-resistant powder composition (A) and, respectively, the grain size of the hard particles (I) makes it possible to prevent the formation of contiguous regions of hard particles that weaken the mechanical durability of a wearing part.

A further benefit of the method according to the invention is that a hard powder composition (A) and a ductile steel powder (B) can be coprocessed in a single pressing step into durable multimaterial structures without the need for establishing special gradient structures between the different material types.

The scope of the invention is not limited to the wearing parts of rock crushers alone, but rather the invention can be also applied to other kinds of wearing parts requiring high resistance to erosion, such as different types of rolls, cylinders, mills, wear-resistant bushings and mandrels, etc. All such wearing parts manufactured according to the invention typically have a structure wherein onto a surface of a low resistance to wear is applied a more wear-resistant but brittler material in such a fashion that the base material is ductile thus being mechanically tough, while the brittler material of good wear-resistance embedded therein is advantageously continuously subjected to a compressive stress. The continuous state of compressive stress is attained by proper selection of materials, additives and thermal treatment.

What is claimed is:

1. A method for manufacturing erosion-resistant wearing parts by a powder-metallurgical multimaterial technique, in which method the wearing part being manufactured is formed from a hard powder composition (A) comprising at least one metal powder and at least one ceramic powder and from at least one ductile powder (B) and from an encapsulating mold, wherein the powders are metered for a subsequent pressing step comprising the densification of the powders in a single pressing step with the help of elevated pressure and temperature into an entirely dense product and the thus obtained wearing part during the solidification phase thereof having the hard powder composition (A) and the ductile powder composition (B) directly contacted with each other without any separately made gradient layer, characterized in that the temperature coefficient of the hard powder composition (A) is controlled by ceramic grain additives so as to keep the temperature coefficient of the hard powder composition (A) smaller than that of the encapsulating ductile powder composition (B), whereby the hard powder composition (A), with the exception of the outer erosion-subjected surface of the wearing part, remains entirely encapsulated by the ductile powder composition (B) so effectively that the imposed eroding forces cannot essentially extrude the hard powder composition (A) out from said wearing part through its erosion-subjected outer surface.

2. The method of claim 1, characterized in that the volume proportion of the hard particles (II) in the hard powder composition (A) is 10-50 vol. %.

3. The method of claim 1 or 2, characterized in that the densification of the powders metered into the mold is performed by hot isostatic pressing at a pressure of 80-150 MPa and temperature of 1050-1200° C.

4. The method of claim 1 or 2, characterized in that the densification of the powders metered into the mold is performed by hot isostatic pressing at a pressure of 90-110 MPa and temperature of 1080-1130° C.

5. A wearing part comprised of a wear-resistant material (A) and a ductile material (B), possibly complemented with portions of the encapsulating mold material adhering to the wearing part, characterized in that the wearing zone of said wearing part contains the wear-resistant material (A), while the rest of the wearing part structure is of the ductile material (B) and of the encapsulating mold material possibly adhering to the wearing part, and that the regions of the wear-resistant material (A) form a metallurgical bond with the ductile material and the remainder of the encapsulating mold material and that the temperature coefficient of the wear-resistant material (A) is smaller than that of the ductile material (B).

6. The wearing part of claim 5, characterized in that the wear-resistant material (A) is comprised of a mixture of a steel powder (I) and a composition of ceramic particles (II) containing not more than 30 wt. % of a metallic binder, whereby said wear-resistant material (A) contains a steel-based metal powder with a steel content greater than 50 wt. %.

7. The wearing part of claim 6, characterized in that the chemical composition of the steel powder component (I) in the composition of the wear-resistant material (A) is C 0.5-3.5 wt. %, Cr 0.5-15 wt. %, Mo 0-5 wt. %, Mn less than 2 wt. %, Si less than 2 wt. % and the proportion of the carbide-forming additives such as V, Nb, Ti and W compounds in total is 3-20 wt. %, while the rest of the composition comprises impurities or trace amounts of different additives.

8. The wearing part of claim 6, characterized in that the chemical composition of the steel powder component (I) in the composition of the wear-resistant material (A) is C 2-3 wt. %, Cr 3-8 wt. %, Mo 0.5-5 wt. %, Mn less than 2 wt. %, Si less than 2 wt. % and the proportion of the carbide-forming additives such as V, Nb, Ti and W compounds in total is 5-15 wt. %, while the rest of the composition comprises impurities or trace amounts of different additives.

9. The wearing part of any one of claims 6-8, characterized in that the average grain size of the steel powder component (I) of the wear-resistant material (A) is smaller than ½ of the average grain size of the ceramic particles (II).

10. The wearing part of any one of claims 6-8, characterized in that the average grain size of the steel powder component (I) of the wear-resistant material (A) is smaller than ⅓ of the average grain size of the ceramic particles (II).

11. The wearing part of any one of claims 6-10, characterized in that the average grain size of the ceramic particles is 200-1500 μm.

12. The wearing part of any one of claims 6-10, characterized in that the average grain size of the ceramic particles is 200-500 μm.

13. The wearing part of any one of claims 5-12, characterized in that the wearing part is erosion-subjected wearing part of a crusher.
